(19) United States
(12) Patent Application Publication
(10) Pub. No.: US 2007/0264111 A1
(43) Pub. Date: Nov. 15, 2007

(54) System for loading, unloading and transporting cargo

(76) Inventor: Diana Cooper, Alexandria, VA (US)

Correspondence Address: TOOD A. VAUGHN, LAW OFFICE OF TODD A. VAUGHN, 5335 WISCONSIN AVE., N.W. Suite 440, WASHINGTON, DC, 20015, US

(21) Appl. No.: 11/430,940

(22) Filed: May 10, 2006

(51) Int. Cl. B60P 1/02

(52) U.S. Cl. 414/497

(57) ABSTRACT

A system for quickly and efficiently loading and unloading cargo into a container of a transport vehicle that averts the likelihood of cargo shifting during loading, unloading and transport. The system includes a moveable support platform extendable within the transport container upon which the cargo is supported and a moveable interior stabilizing platform secured to the support platform which prevents the shifting of cargo during loading, unloading and transport. The stabilizing wall also serves to align stacked rows of cargo on the support platform.

### BACKGROUND OF THE INVENTION

1. Field of the Invention

This invention relates generally to system for quickly and efficiently loading and unloading transportable articles or cargo into a container of a vehicle. More particularly, the invention relates to such a system having a moveable support platform extendable within the transport container and having a substantially horizontal support surface or area upon which the cargo is supported and a moveable interior stabilizing mechanism connected to the support platform that includes a substantially vertical stabilizing surface which prevents the shifting of cargo during loading, unloading and transport.

2. Description of the Related Art

A wide variety of systems for loading, unloading and transporting cargo into and/or from a container, such as shipping containers or trailers, include a conveyor having a support surface for supporting the cargo such as baggage pieces, containers, boxes, furniture and the like in a stacked arrangement. The conveyor is adaptable for extension into the container and is driven by a drive mechanism for movement along a conveying path inside the container.

During a loading sequence, a plurality of rows of cargo is sequentially stacked manually on the conveying surface, commencing at the front end of the container. The conveyor is sequentially displaced rearward towards the aft or rear end wall of the container until the first stackable row abuts or otherwise engages the rear wall. Once the loading sequence is complete, the container is sealed shut by a door or wall located at the front section of the container.

Numerous disadvantages have been found in the prior art systems that results in various inefficiencies, increased transport costs, and damage or destruction of the cargo during loading, unloading and transport.

One disadvantage occurs when the container is not filled to its maximum volumetric capacity. In this instance, a space or gap is created between the last stacked row of cargo at the front section of the container and the inner surface of the container door. Such a gap results in the unwanted shifting of cargo during transport and also during displacement of the conveyor towards the aft or rear section of the container. Accordingly, severe damage to the cargo results. Such damage during loading and/or unloading will result in an increase in transport costs to both the owner and transporter.

Another disadvantage found in prior art systems occurs during an unloading sequence through the creation of a second space or gap between the rear container wall and the first stackable row as the conveyor is displaced towards the front section of the container. Such a gap causes unwanted shifting of the cargo, and results in damage and/or destruction thereto.

An additional disadvantage found in prior art systems occurs during the commencement of a loading sequence. Particularly, the lack of vertical support makes it difficult to create a series of stackable rows, i.e., rows that rest one on top of the other in parallel, that extend from the support surface of the conveyor to the top of the container ceiling. This lack of a vertical support results in slow, inefficient stacking of rows at such low heights to limit shifting or falling of the stacked cargo. This results in a container not being filled to its maximum capacity, which results in increased transport costs.

A further disadvantage found in prior art systems occurs as a result of operator or mechanical error during an unloading sequence, whereby continued displacement of the conveyor system results in one or more rows of stacked cargo falling from the conveyor and out of the front section of the container and to the ground. This results in damage and/or destruction to the cargo, which also leads to increased transport costs.

### SUMMARY OF THE INVENTION

Accordingly, it is an object of the invention to provide a system for the quick, efficient and economic loading, unloading and transport of cargo.

It is another object of the invention to provide such a system which prevents the occurrence of shifting of cargo during loading, unloading and transport.

It is an additional object of the invention to provide such a system that prevents the cargo from being damaged or destroyed during loading, unloading and transport.

It is a further object of the invention to provide such a system that prevents the creation of gaps between the cargo and the front and rear container walls which causes shifting.

It is yet another object of the invention to provide such a system that averts shifting of cargo during displacement of the support platform.

It is still another object the invention to provide such a system which increases the possibility of loading a container to its maximum capacity.

Yet and still, another object the invention is to provide such a system that is easily portable.

Yet and still, an additional object of the invention is to provide such a system having means for sensing an occurrence of a condition or a change in condition and in response thereto acts to start, stop, or change the manner of operation of the system.

Yet and still, a further object of the invention is to provide such a system having means for dampening or otherwise absorbing shocks, impacts, pressure loads, etc. transmitted by the stacked cargo 11 during loading, unloading and transport.

In accordance with these objects and the principles of the invention, provided herein in one embodiment is a portable system for loading and unloading transportable cargo that includes: (a) a support platform having a substantially horizontal support surface upon which the transportable cargo is loaded, the support platform being moveable between a starting position adjacent a forward end of the support platform to a resting position adjacent an aft end of the support platform, the support platform also being movable from a compact, resting position to an retracted, working position; and (b) a stabilizing mechanism removeably attached to the support platform having a substantially vertical stabilizing surface for preventing the shifting of cargo during at least one of loading, unloading and transporting the cargo and for aligning stackable rows of cargo on the support platform, the stabilizing mechanism being moveable with the support platform.

In accordance with another aspect of the invention, provided herein is a system for loading and unloading transportable cargo into and out of a transport vehicle container, the system including: (a) a support platform longitudinally extendable into the container and upon which the transportable cargo is supported, the support platform having a discharge end adjacent a forward end of the container and a rear end adjacent an aft end of the container, the support platform being moveable along a substantially longitudinal conveying path between the forward and aft ends of the container; (b) a stabilizing mechanism aligned substantially perpendicular relative to the support platform for preventing the shifting of cargo during at least one of loading, unloading and transporting the cargo and maintaining the alignment of stackable rows of cargo on the support platform, the stabilizing mechanism being moveable with the support platform between a starting position adjacent the forward end of the support platform to a resting position adjacent the aft end of the support platform; and (c) at least one sensing mechanism for sensing the location of the stabilizing mechanism and automatically deactivating the support platform once the stabilizing mechanism reaches a predetermined spatial distance relative to the support platform.

In accordance with yet another aspect of the invention, provided herein is a system for supporting transportable cargo during loading and unloading sequences including: (a) a substantially horizontal support surface for moveably supporting the cargo along a substantially longitudinal conveying path between forward and aft ends of the container; (b) a substantially vertical stabilizing surface supported by the support surface for preventing the shifting of cargo during displacement of the support surface and also for maintaining the spatial integrity of stackable rows of cargo on the support surface; and (c) a mechanism for dampening forces transmitted by the cargo during loading, unloading and transport, the dampening mechanism being located on the stabilizing surface at points of contact between the cargo and the stabilizing surface.

Accordingly, the system in accordance with the invention is advantageous in being adaptable facilitate the quick and efficient loading and unloading of transportable goods by eliminating the threat of unwanted shifting and falling of cargo during loading/unloading sequences and transport. Particularly, use of a stabilizing mechanism or vertical support surface permits the stacking of a plurality of rows of cargo from the surface of the support platform to the ceiling of the container ceiling.

A portable system is beneficial since it is easy to install and break down, which saves both time and money. The portable system also is ideal for small moving jobs, and can be used by both professional and non-professional movers. The portable system is convenient, and may be sized to fit into one or more wheeled cases that can be easily moved to any desired location or destination.

A system having sensing capability with automatic shutdown of the system is beneficial for preventing damage and/or destruction to the cargo as result of continued displacement of the conveyor system during loading or unloading.

A system having a dampening mechanism for absorbing dampening forces transmitted by the cargo during loading, unloading and transport is beneficial for maintaining the structural integrity of the system during operation as well as assisting with the prevention of shifting of cargo.

These and other objects, features and advantages of the invention will become more apparent from the following description when taken in conjunction with the detailed drawings that show, for purposes of illustration only, the preferred embodiments of the invention.

### BRIEF DESCRIPTION OF THE DRAWINGS

The invention is described through a preferred embodiment illustrated in the accompanying drawings in which corresponding elements are labeled with the same reference numerals, wherein:

FIG. 1 is a rear perspective view of the system;

FIG. 2 is a frontal view of the system;

FIG. 3 is a side view of the system during a loading sequence having a plurality of stacked rows of cargo loaded in a container;

FIG. 4 is a side view of the system showing a container partially filled to capacity;

FIG. 5 is a side view of the system in another embodiment of the invention showing a container partially filled to capacity;

FIGS. 6A & 6B are perspective and side views of a portable support platform in extended and retracted positions;

FIG. 7 frontal view of a stabilizing platform having a single dampening member;

FIG. 8 shows side view of the stabilizing platform illustrated in FIG. 7;

FIG. 9 frontal view of a stabilizing platform having a plurality dampening members; and

FIG. 10 shows side view of the stabilizing platform illustrated in FIG. 9.

### DETAILED DESCRIPTION OF THE INVENTION

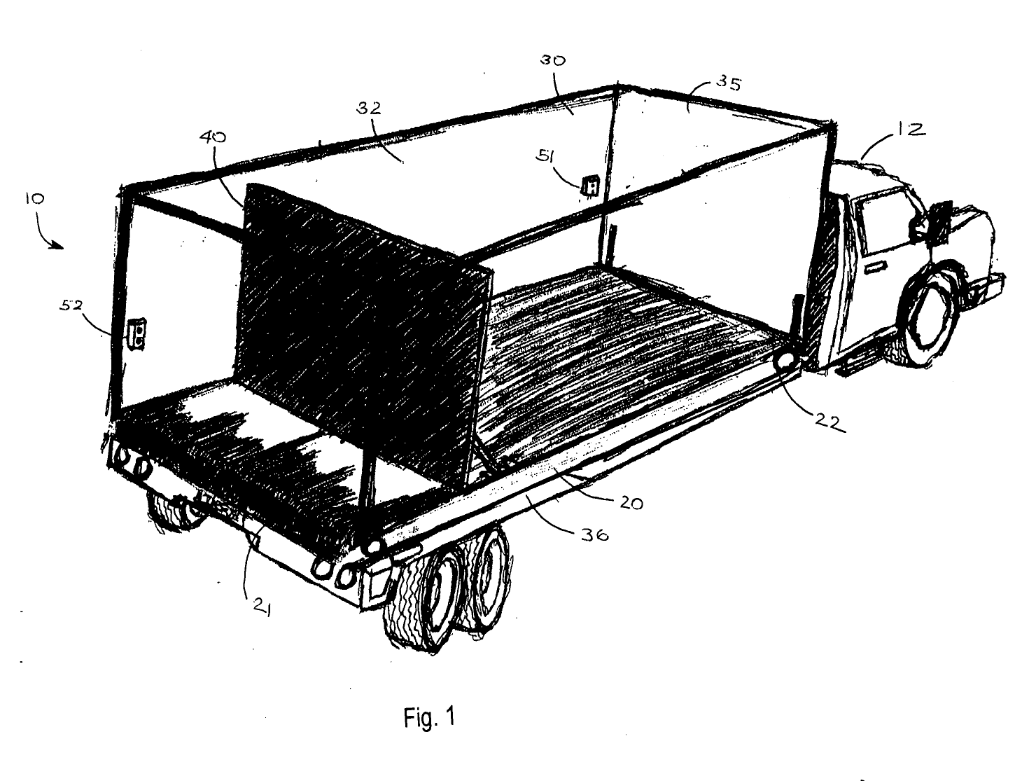

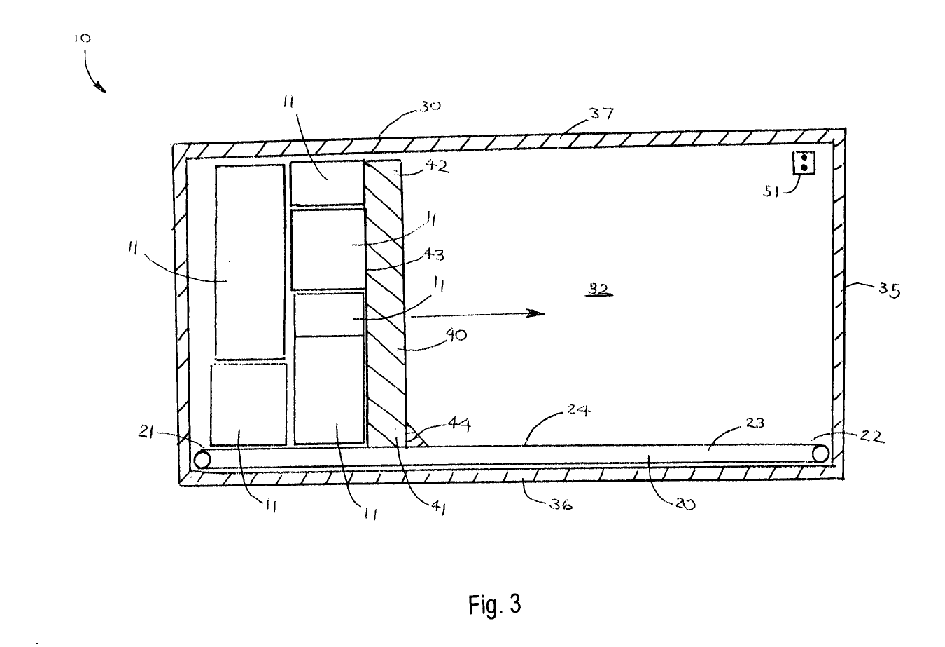

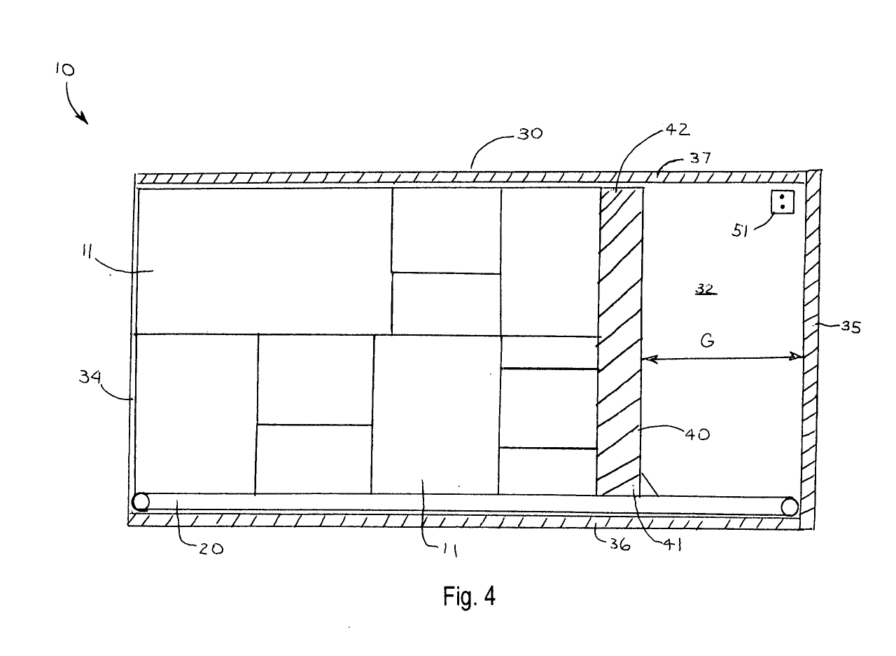

As shown in FIGS. 1-5, the system 10 for loading and unloading cargo 11, in this particular instance in a transport vehicle 12, includes a support platform 20 longitudinally extendable into a transport container 30, and a stabilizing platform 40 aligned substantially perpendicular relative to the support platform 20 for preventing the shifting of cargo 11 during at least one of loading, unloading and transporting and maintaining the spatial alignment of stackable rows of cargo 11 on the support platform 20. As noted herein, a transport container is defined as including shipping containers, a storage compartment of a motor vehicle, a trailer section of a motor vehicle, and other comparable items which permit the storage of cargo, goods and the like.

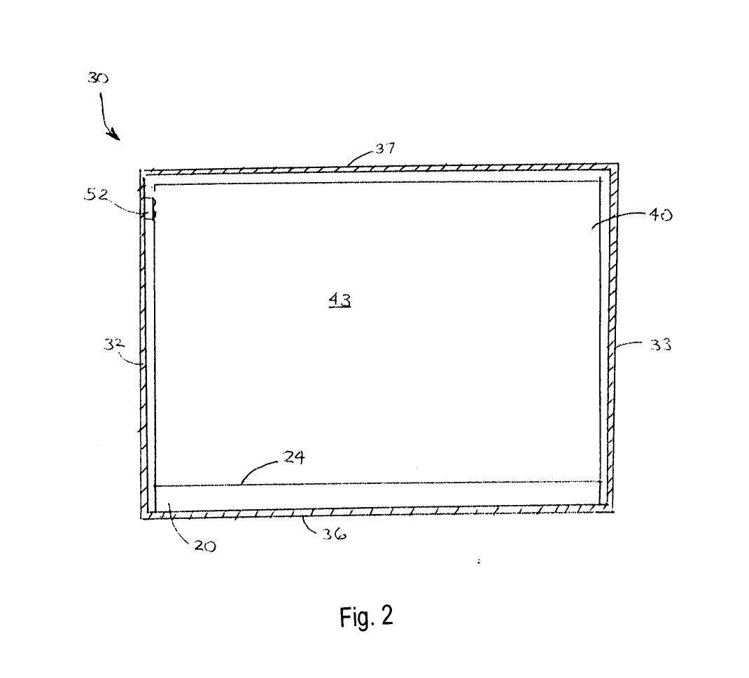

FIGS. 2-5 illustrate a container 30 having a pair of opposing side walls 32, 33, a retractable or pivotal door 34 provided at a front/forward end, a back wall 35 provided at a rear/aft end, a base floor 36 and an upper wall or ceiling 37 that define an internal space which receives the system 10 as well as the cargo 11. The retractable or pivotal door 38 is moveable between an open position which permits the loading and unloading of cargo 11 into the container 30 and a closed position for transport of the cargo 11 to a particular destination.

As illustrated in FIGS. 1-3, the support platform 20 lies substantially horizontal relative to the container 30, and hence, substantially parallel to the container floor 36. In a preferred embodiment of the invention, the support platform 20 is an endless belt conveyor 23 constructed as a substantially flat, flexible member having an upper support surface 24 upon which the transportable cargo 11 are moveably supported. The support platform 20 further includes the previously mentioned discharge end 21 located adjacent a forward end 34 of the container 30 and a rear end 22 located adjacent an aft end 35 of the container 30. The support platform 20 is moveable along a substantially longitudinal conveying path (see arrow) between the forward 34 and aft ends 35 of the container 30 during loading and unloading sequences. While the conveyor 22 is shown using an endless belt system, it can be appreciated by those skilled in the art that other suitable conveying systems can alternatively be used to practice the invention. Conventional controls (not shown) may be used for operating the support platform 20 for forward or reverse displacement or motion. It will be appreciated by those skilled in the art that the support platform 20 may be sized to conform to the spatial dimensions of the container, or any size necessary to conduct loading, unloading and transport operations.

The support platform 20 is engaged by at least one indexing or drive mechanism such as a motor (not shown) at a conveying speed sufficient to permit a plurality of stacked rows of cargo 11 to maintain its spatial integrity on the upper surface 24 of the support platform 20. The drive mechanism can take the form of any type of mechanism suitable to provide the necessary indexing motion (forward and reverse) to the support platform 20 during loading and unloading sequences. The support platform 20 also includes a plurality of mounting tabs (not shown) which facilitates permanent or temporary attachment mounting to the floor of the chassis, container floor and the like.

It will be appreciated by those skilled in the art that conveyor 22 may have a unitary construction, or split with a link or attachment mechanism (now shown) for assembly in situ. Conveyors of the type having a plurality of parallel, spaced-apart, endless-loop belts are well known in the art, typical examples being disclosed in U.S. Pat. No. 4,006,831 and U.S. Pat. No. 4,530,632, which are hereby incorporated by reference.

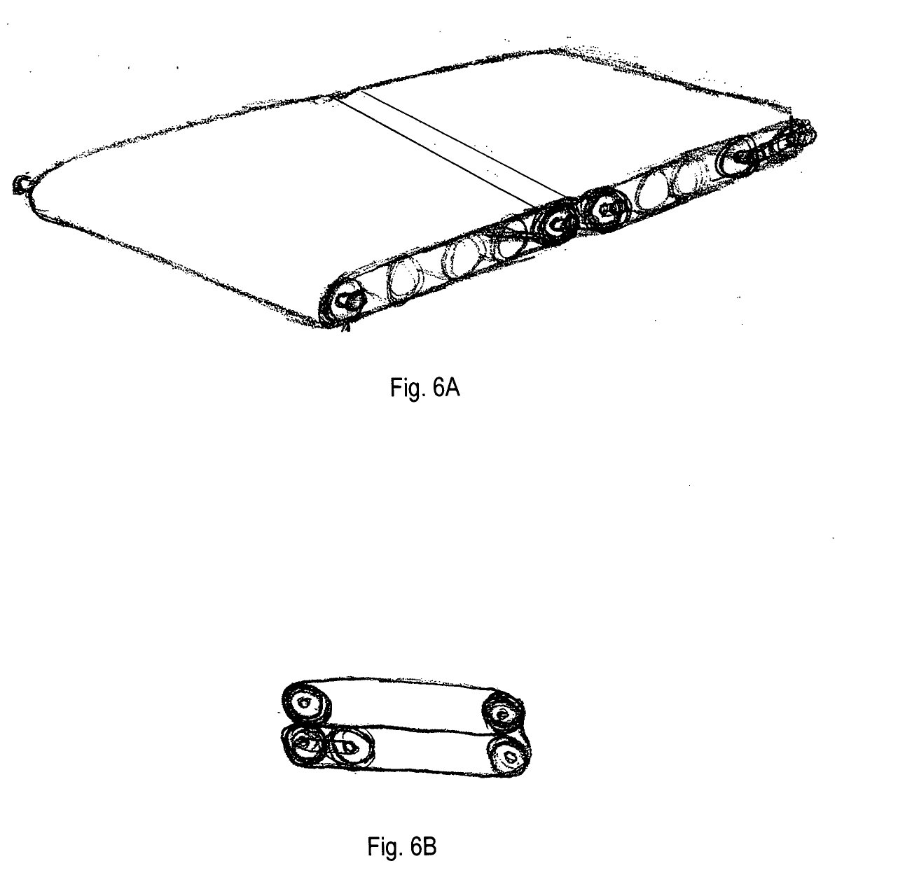

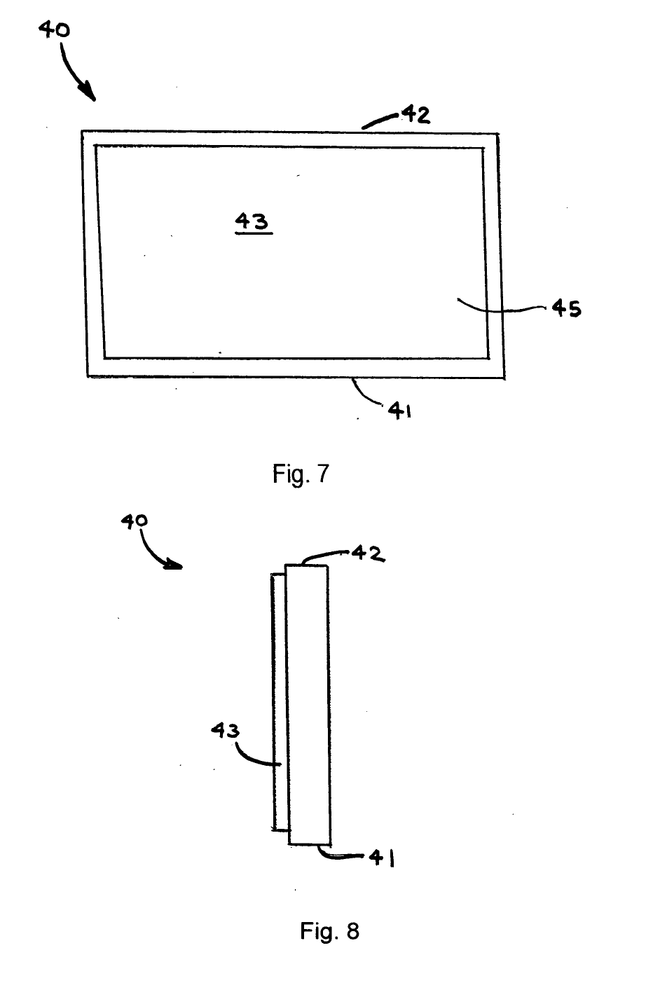

In another embodiment illustrated in FIGS. 6A and 6B, the support platform 20 includes an endless belt conveyor 23 that be manipulated from a substantially flat, working position (FIG. 6A) to a more compact configuration (FIG. 6B) when not in operation. The support platform 20 is hinged to permit its folding for placement into a wheeled carrier. This permits the system 10 to be portable, and thus, used by both professionals and non-professional transporters.

The stabilizing platform 40 is a substantially rectangular structure having a basal end 41 adjacent the support surface 21 and a distal end 42 adjacent the upper wall of the container. Because the stabilizing platform 40 moves during displacement of the support platform 20, a sufficient vertical gap or space should exist between the distal end 42 and the upper wall 37 of the container so as not to impede the displacement of the support platform 20. Essentially, the distal end 42 should not abut, touch, contact or otherwise engage any portion of the upper wall 37. A sufficient horizontal gap or space should also exist between the left and right side of stabilizing platform 40 and the sidewalls 32, 33 to prevent any engagement between these elements. The space should be sized such that cargo 11 cannot become lodged or trapped therein.

The stabilizing platform 40 lies in a substantially vertical position relative to the support platform 20, and hence, substantially perpendicular to the support surface 24. The stabilizing platform 40 includes a stabilizing surface 43 which abuts or otherwise is engaged by the first plurality of stacked rows of cargo 11. The stabilizing surface 43 may be a homogenous portion of the stabilizing platform 40 or laminated on the outer surface thereof. The stabilizing platform 40 may also be expandable vertically and/or laterally so as to spatially conform to the size of the container 30. Any suitable means known in the art may be used to accomplish the expansion of the stabilizing platform 40.

Because the stabilizing platform 40 is removeably mounted on the stabilizing platform 40, it moves simultaneously therewith between an initial position adjacent the forward or discharge end 21 of the support platform 20 to a resting position adjacent the aft end 22 of the support platform 20. A pair of mounting brackets or legs 44 may be provided to removeably mount or otherwise secure the stabilizing platform 40 on the support platform 20. The legs 44 insure that the stabilizing platform 40 provides load resistance against forces from the cargo 11 during loading, unloading and transport. The rear end wall 36 of the container may include a pair of compartments 38, 39 for receiving the support legs 44 of the stabilizing platform 40 once the stabilizing platform 40 is moved to the rear resting position. It can be appreciated by those of ordinary skill that other suitable mounting arrangements may be used to attach the stabilizing platform 40 to the support platform 20.

The stabilizing platform 40 is preferably composed of one or more lightweight, yet robust materials such as metals, woods, composites or other suitable materials. The stabilizing surface 43 may be composed of the same material as the base material for the platform 40. It is preferred, however, that the stabilizing surface 41 be composed of a material offering suitable frictional resistance to the stacked rows of cargo 11 to prevent shifting during displacement of the support platform 20 or during transport. Hence, a material such as a polymeric rubber or other suitable material is preferred.

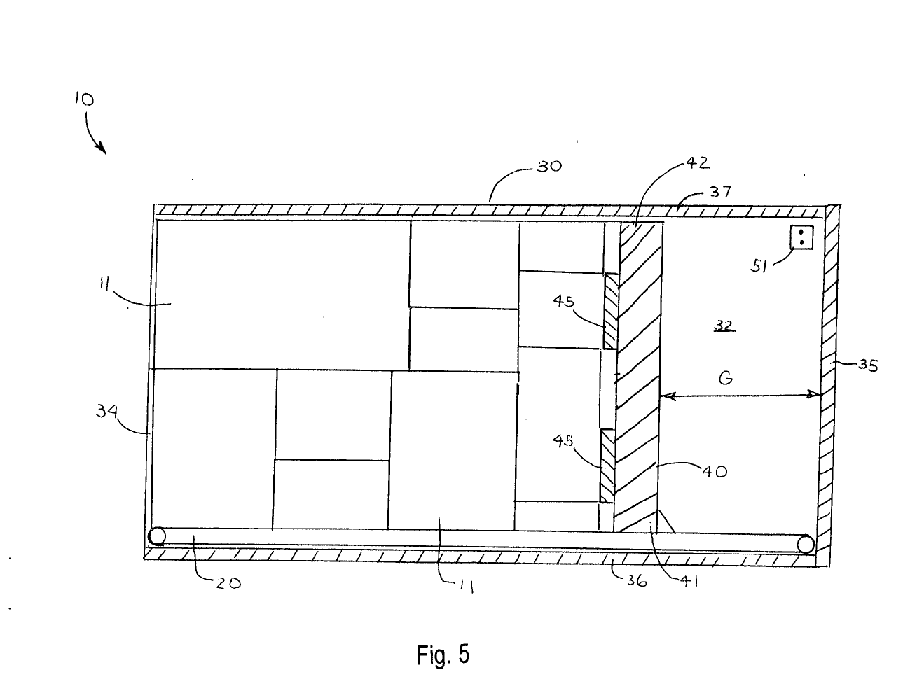

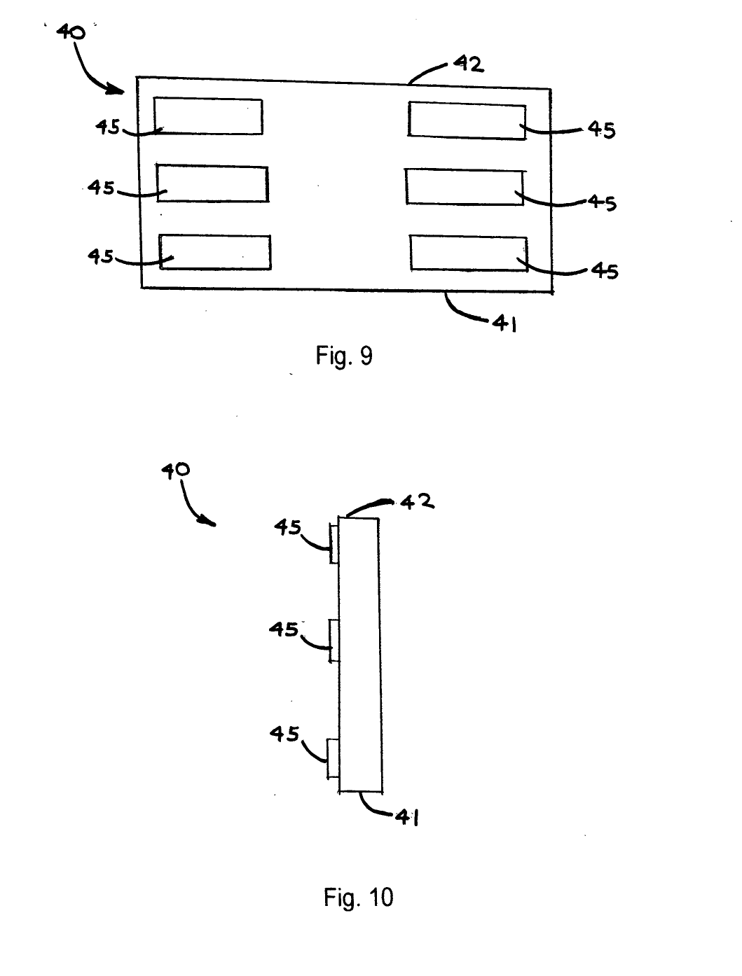

As illustrated in FIGS. 5, 78, 9 and 10, the stabilizing surface 43 may be equipped with means for adequately dampening or absorbing shocks, impacts, pressure loads, etc. transmitted by the stacked cargo 11 during loading, unloading and transport. Such means may include one, two or a plurality of shock absorbing members 45 which protrude from the stabilizing surface 43 and are positioned by direct or indirect (i.e., attachment using intermediary components) attachment along the stabilizing surface 43. The shock absorbing members 45 may also be aligned in one, two or a plurality of rows laterally along the stabilizing surface 43. The shock absorbing members 45 can alternatively be positioned inside an annular space of the frame of the stabilizing platform 40, or be a homogenous structure with the stabilizing surface 43. The shock absorbing members 45 are preferably composed of a suitable material, such as a polymeric rubber, that offers sufficient resilience in absorbing impact forces during engagement with the cargo 11.

FIGS. 1-3 also illustrate a system 10 that further includes a mechanism 50 for sensing the occurrence of a condition or a change in condition and in response thereto acts to start, stop, or change the manner of operation of either the moveable support platform 20 or its carrier. Particularly, the system 10 includes at least one position sensor 50, located preferably adjacent to the forward 21 and aft 22 ends of the support platform 20, which is in communication with the drive mechanism for the support platform 20. The position sensor(s) 50 senses the linear distance of the stabilizing platform 40 relative to the forward 21 and aft 22 ends and automatically deactivates the support platform 20 once the stabilizing platform 40 reaches a certain threshold linear distance. For example, during a loading sequence, once the stabilizing platform 40 reaches the threshold distance relative to the aft end 22, a rearwardly positioned position sensor 51 senses the position of the platform 40 and automatically transmits a signal which deactivates the driving mechanism for the support platform 20, i.e., stops the reverse motion thereof. On the contrary, during an unloading sequence, once the stabilizing platform 40 reaches the threshold distance relative to the forward end 21 of the support platform 20, a forwardly positioned position sensor 52 senses the position of the stabilizing platform 40 and transmits a signal which automatically deactivates the driving mechanism for the support platform 20, i.e., stops the forward motion thereof.

In the operation of the system 10 during a loading sequence, the support platform 20 is displaced in a forward direction and is stopped once the threshold distance between position of the stabilizing platform 40 is forward sensor 51 so that the stabilizing platform 40 is placed in its initial position adjacent the forward end 21 of the support platform 20 leaving enough horizontal space thereon to permit the placement of cargo 11. Cargo 11 is then stacked on the horizontally-extending support surface 24 while being stabilized by the vertically-extending stabilizing platform 40. Because the stabilizing platform 40 extends from the support surface 24 to an area adjacent the container ceiling 37, a first plurality of stackable rows of cargo 11 can be positioned on the support platform 20. The support platform 20 is then sequentially indexed in a rearward direction to permit the transfer of additional cargo 11 on the support surface 24. Once the loading sequence is completed, the container door 34 is closed and locked shut. For instances in which a less than full amount of cargo is transferred into the container 30, a horizontal gap G is created between the stabilizing platform and the back wall 35 of the container 30. However, because the cargo 11 is sandwiched between the container door 34 and the stabilizing platform 40 and or the dampening member(s) 45, the occurrence of cargo shifting during transport is obviated.

It is apparent that innumerable variations of the preferred embodiments described hereinbefore may be utilized. However, all such variations within the spirit and scope of the invention are deemed to be covered by the following claims.

What is claimed is:

1. A portable system for loading and unloading cargo comprising:
(a) a support platform having a substantially horizontal support surface upon which the cargo is loaded, said support platform being moveable between a starting position adjacent a forward end of said support platform to a resting position adjacent an aft end of said support platform, said support platform also being movable from a compact, resting position to an extended, working position; and
(b) a stabilizing platform removeably mounted on said support platform having a substantially vertical stabilizing surface for preventing the shifting of cargo during at least one of loading, unloading and transporting the cargo and for maintaining the spatial alignment of stackable rows of cargo on said support platform, said stabilizing platform being moveable with said support platform.

2. The system of claim 1, wherein said support platform comprises a flexible endless conveyor belt.

3. The system of claim 2, wherein said endless conveyor is driven by a drive mechanism.

4. The system of claim 1, wherein said support platform comprises a plurality of telescopically moveable support surfaces interconnected to each other and when fully extended form a continuous support platform.

5. The system of claim 4, wherein said support surfaces are mounted on a plurality of wheels which are moveable within a pair of guide channels.

6. The system of claim 1, wherein said stabilizing platform is mounted on said support platform.

7. The system of claim 6, further comprising a pair of mounting mechanisms for mounting said stabilizing platform on said support platform.

8. The system of claim 7, wherein said mounting mechanisms comprises a pair of braces provided on a rear vertical surface of said stabilizing platform.

9. A system for loading and unloading cargo into a transport vehicle container, said system comprising:
(a) a support platform longitudinally extendable into the container and upon which the cargo is supported, said support platform having a discharge end adjacent a forward end of the container and a rear end adjacent an aft end of the container, said support platform being moveable along a substantially longitudinal conveying path between the forward and aft ends of the container;
(b) a stabilizing platform aligned substantially perpendicular relative to said support platform for preventing the shifting of cargo during at least one of loading, unloading and transporting the cargo and maintaining the spatial alignment of stackable rows of cargo on said support platform, said stabilizing platform being moveable with said support platform between a starting position adjacent the forward end of said support platform to a resting position adjacent the aft end of said support platform; and
(c) means for sensing the linear distance of said stabilizing platform relative to said support platform and automatically deactivating the support platform once said stabilizing platform reaches a threshold linear distance.

10. The system of claim 9, wherein said at least one sensing mechanism comprises a pair of sensing mechanisms located adjacent the forward and aft ends of said support platform.

11. The system of claim 9, wherein said stabilizing platform includes a dampening mechanism which dampens forces transmitted by the cargo during loading, unloading and transport.

12. The system of claim 11, wherein said dampening mechanism comprises at least two dampening members located at contact areas on said stabilizing platform.

13. The system of claim 9, wherein said dampening mechanism comprises at least one dampening member positioned inside an annular space within said stabilizing platform.

14. A system for supporting cargo during loading and unloading sequences comprising:
(a) a substantially horizontal support surface for moveably supporting the cargo along a substantially longitudinal conveying path between forward and aft ends of the container;
(b) a substantially vertical stabilizing surface supported by said support surface for preventing the shifting of cargo during displacement of said support surface and also for maintaining the spatial integrity of stackable rows of cargo on said support surface; and
(c) means for dampening forces transmitted by the cargo during loading, unloading and transport, said dampening means being located on said stabilizing surface at points of contact between the cargo and said stabilizing surface.

15. The system of claim 14, wherein said dampening means comprises at least one dampening member secured by direct or indirect attachment on said stabilizing surface.

16. The system of claim 14, wherein said dampening members are positioned inside an annular space within said stabilizing platform.

17. The system of claim 14, further comprising a sensing mechanism in communication with said support surface for sensing the linear location of said stabilizing surface relative to a discharge area of said support surface and stopping the forward or reverse displacement of said support surface once said stabilizing surface reaches a threshold linear distance.
